(19) United States
(12) Patent Application Publication
(10) Pub. No.: US 2011/0185654 A1
(43) Pub. Date: Aug. 4, 2011

(54) LOCK JOINT FOR WINDOW AND DOOR CASINGS

(76) Inventor: Howard D. Jostad, Henderson, MN (US)

(21) Appl. No.: 12/698,445

(22) Filed: Feb. 2, 2010

(51) Int. Cl. E06B 1/04; E06B 1/62

(52) U.S. Cl. 52/212; 52/745.16; 49/504

(57) ABSTRACT

The invention provides a method for providing improved and locking joints in window and door casings. Complementary geometric shapes are provided on each adjacent joint member to provide locking engagement thereof. This locking engagement helps prevent the gaps that typically result in known 45 degree miter joints as a result of expansion and contraction due to water uptake and release.

### BACKGROUND OF THE INVENTION

1. Field of the Invention

The invention relates to a device and method for providing improved joints in window and door casings.

2. Description of the Related Art

Windows and doors are typically enclosed with a framing casing structure as illustrated in FIGS. 1A and 1B. The typical window casing will comprise a four-sided structure while a typical door casing requires a three-sided structure. A horizontal member 12 is illustrated with a vertical member 14, joined by a 45 degree miter joint 20, the vertical member miter cut illustrated as 16 and the horizontal member miter cut as 18, the miter joint 20 being the connection between the vertical 16 and horizontal 18 member miter cuts. As is well known, a three-sided door casing will typically comprise a single overhead horizontal member 12 and two vertical members 14, the vertical members 14 forming a miter joint 20 with the mitered ends of the horizontal member 12. Similarly, a four-sided window casing will generally comprise an upper horizontal and a lower horizontal member with two vertical members therebetween, each of the four connection points being joined with a 45 degree miter joint 20. FIG. 1A illustrates the miter joint 20 as being essentially gap-free. Thus, in this illustration, the vertical miter cut 16 and the horizontal miter cut 18 fit together virtually perfectly, providing the desired tight fit. Most typically, the degree of angles formed at all corners of the framing casing structure is approximately 90 degrees between adjacent members.

Unfortunately, the miter joint 20 rarely provides a tight fitting joint on the first try. Even using a miter box set exactly on 45 degrees may not result in a tight fit on the first try for many reasons. The artisan must then either attempt to adjust the angle on the miter box slightly and recut or attempt to shave the previously cut but ill-fitting members in order to achieve a good tight fit.

Moreover, once the desired tight fitting miter joint 20 is achieved, it is very common for the once-tight joint 20 to pull apart, with the once-joined members essentially retracting from each other, resulting in loss of aesthetics and function. This pulling apart of the joint 20 may be caused by one or more conditions. A primary cause involves the permeability of wood typically used in such casings to water. Since this wood absorbs and releases moisture relatively easily, the vertical and horizontal members of the casings will expand and contract accordingly depending on ambient humidity conditions.

By way of example, if the conditions were relatively humid when the casing was installed, the vertical and horizontal members will be at, or near, a maximum expansion, as in the summer months in the upper Midwestern part of the United States. As the atmospheric humidity decreases post-installation during the fall and winter months, the vertical and horizontal members will naturally lose moisture and will contract in size. This contraction will, inter alia, result in a loss of tight fit of the vertical miter and horizontal miter cuts 16, 18, resulting in a gap of the previously tight miter joint.

One embodiment of this problem is illustrated in FIG. 1B. The opened gap 22 in the previously tight fitting miter joint 20 of FIG. 1A forms as a result, e.g., of loss of moisture in the horizontal and vertical members 12, 14 after installation and formation of miter joint 20. As the skilled artisan will readily understand, a loss of moisture in the wooden members 12, 14 will result in their contraction which, in turn, creates gap 22.

The formation of gap 22 is highly undesirable, both from an aesthetic as well as a functional and energy efficiency standpoint. As a result, artisans attempt to mitigate this problem by a variety of techniques, none of which completely solves the problem. Some of these mitigating techniques include gluing the miter cuts 16, 18 to prevent them from pulling apart. In addition, sealing any open, non-stained or non-painted surfaces to prevent moisture uptake and/or release is used. However, none of these techniques provide a satisfactory solution as they fail to prevent the gap 22 from forming, they simply attempt to reduce the size/width of gap 22.

Note here that gap 22 is illustrated in FIG. 1B as having a substantially equal width over its length. This may be interpreted as a case wherein the horizontal member 12 and vertical member 14 comprise wood of substantially similar moisture content when installed and/or having substantially the same moisture content capabilities, so that each member 12, 14 takes substantially the same moisture up and releases the same moisture amount. It may, however, be the case wherein one of the members 12, 14 comprises a different moisture content profile and, as a result, the gap 22 may not comprise an equal width over its length. In any case, gap 22 is undesirable and is not satisfactorily fixed or mitigated using any known techniques.

The present invention overcomes these deficiencies.

### BRIEF SUMMARY OF THE INVENTION

The invention provides a device and method for forming window and/or door casings that lock tight and do not gap.

An object of the invention is to provide a method for forming window and door casings that comprise tight locking elements that do not gap.

Another object of the invention is to provide a device for cutting the vertical and horizontal members comprising the window and/or door casings that comprise tight locking elements that do not gap.

The figures and the detailed description which follow more particularly exemplify these and other embodiments of the invention.

### BRIEF DESCRIPTION OF THE DRAWINGS

The invention may be more completely understood in consideration of the following detailed description of various embodiments of the invention in connection with the accompanying drawings, which are as follows.

FIG. 1A is a broken away front view of one embodiment of a known casing construction.

FIG. 1B is a broken away front view of one embodiment of a known casing construction.

FIG. 2 is a perspective broken away view of one embodiment of a horizontal member of the present invention.

FIG. 3 is a front view of one embodiment of an upper horizontal member of the present invention;

FIG. 3A is a front view of one embodiment of an upper horizontal member of the present invention;

FIG. 4 is a front view of one embodiment of a lower horizontal member of the present invention;

FIG. 5 is a perspective view of one embodiment of a right side vertical member of the present invention;

FIG. 6 is a front broken away view of one embodiment of a right side vertical member of the present invention;

FIG. 6A is a front broken away view of one embodiment of a right side vertical member of the present invention;

FIG. 7 is a front broken away view of one embodiment of a left side vertical member of the present invention;

FIG. 7A is a front broken away view of one embodiment of a left side vertical member of the present invention;

FIG. 8 is a front view of the upper right corner of one embodiment of the present invention;

FIG. 9 is a front view of the upper left corner of one embodiment of the present invention;

FIG. 10 is a front view of the lower left corner of one embodiment of the present invention; and

FIG. 11 is a front view of the lower right corner of one embodiment of the present invention.

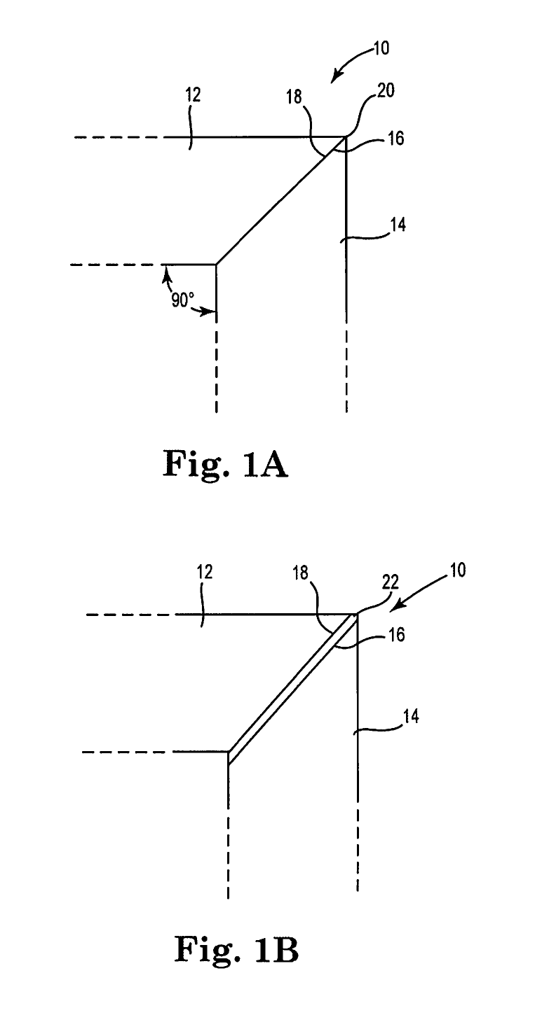

### DETAILED DESCRIPTION OF THE INVENTION

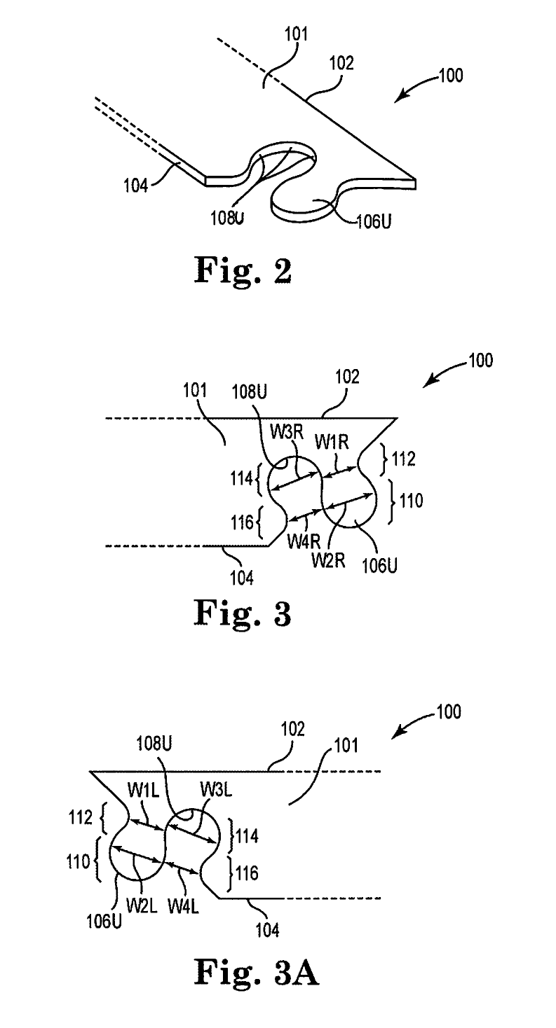

FIGS. 2, 3 and 3A illustrate one embodiment of the right side of a horizontal member, specifically an upper horizontal member 100. The upper horizontal member 100 comprises a body 101 and an elongated horizontal surface 102 and a shortened horizontal surface 104 on opposing sides of the body 101. The member 100 further comprises a male engager 106U and a female engaging surface 108U defined on the right side of the body 101.

The male engager 106U comprises a head 110 and a neck 112, each comprising a width, wherein the head 110 maximum width W2R is wider than the neck 112 minimum width W1R.

Similarly, the female engaging surface 108U comprises a head section 114 and a neck section 116, each comprising a width, wherein the head section 114 maximum width W3R is wider than the neck section 116 minimum width W4R.

As noted, FIGS. 2 and 3 illustrate the right side of the upper horizontal member 100. Turning now to FIG. 3A, an embodiment of the left side of the upper horizontal member 100 is illustrated. The illustrated embodiment of the left side of the upper horizontal member 100 comprises the same structure and relative dimensions as that illustrated and described above in connection with FIG. 3, i.e., comprising a mirror image of the structure of the right side of the upper horizontal member 100.

Thus, male engager 106U and female engaging surface 108U are also defined on the left side of the body 101. The male engager 106U further comprises a head 110 and a neck 112, each comprising a width, wherein the head 110 maximum width W2L is wider than the neck 112 minimum width W1L.

The left side of body 101 also comprises female engaging surface 108U, which further comprises a head section 114 and a neck section 116, each comprising a width, wherein the head section 114 maximum width W3L is wider than the neck section 116 minimum width W4L.

In a preferred embodiment, the dimensions of the male engager 106U and the female engaging surface 108U are the same on the right side and the left side of the body 101 of upper horizontal member 100. Thus, W1R=W1L; W2R=W2L; W3R=W3L; and W4R=W4L is a preferred case. However, the present invention is not intended to be limited to this preferred embodiment. Further, the male engager 106U and female engaging surface 108U need not be circular or curvilinear as illustrated; instead geometric patterns or shapes, i.e., triangles or squares, etc. Therefore, the dimensions and geometric shape(s) of the right side male engager 106U and female engaging surface 108U may differ from those of the left side male engager 106U and female engaging surface 108U. What is required in all embodiments is that the male engager 106U comprises a head 110 with a maximum width that is wider than the minimum width of the neck 112 and that the female engaging surface 108U comprises a head section 114 with a maximum width that is wider than the minimum width of the neck section 116.

In the case of a door casing, which needs a three-sided casing, only an upper horizontal member 100 is typically required. However, for four-sided window casings, a lower horizontal member (not shown) is also needed. Thus, as will be readily understood by the skilled artisan, the lower horizontal member may be of the same shape and comprise the same design considerations as the upper horizontal member, with the only difference being that the elongated horizontal surface will be on the lower portion of the lower horizontal member. In practice, the upper horizontal member 100 would simply be rotated 180 degrees by the artisan. Thus, the lower horizontal member comprises a further embodiment of the present invention.

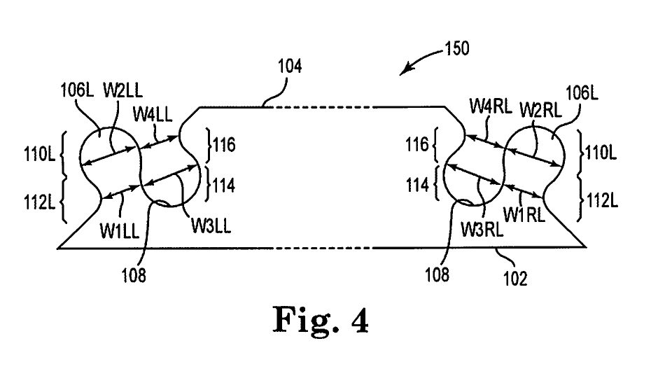

One embodiment of the lower horizontal member 150 is illustrated in FIG. 4. As shown, member 150 is substantially duplicative in structure and geometry as the upper horizontal member 100; the two members 100, 150 are simply mirror images of each other. This is a preferred embodiment and is not intended to be limiting in any respect in terms of shape, size or geometry except as indicated herein.

Thus, the lower horizontal member 150 also comprises right and left male engagers 106L, each further comprising a head 110L and a neck 112L, wherein the head 110L and neck 112L comprise a width, wherein the right and left head 110L comprise a maximum width W2RL, W2LL that is wider than the right and left neck 112L minimum width W1RL, W1LL, respectively.

Similarly, the right and left female engaging surfaces 108L comprise a right and left head section 114L and a right and left neck section 116L, each further comprising a width, wherein the right and left head section 114L each comprise a maximum width W3RL, W3LL is wider than the right and left neck section 116L minimum width W4RL, W4LL, respectively.

In a preferred embodiment, as with the upper horizontal member 100 discussed above, the dimensions of the male engager 106L and the female engaging surface 108L are the same on the right side and the left side of the lower horizontal member 150. Thus, W1RL=W1LL; W2RL=W2LL; W3RL=W3LL; and W4RL=W4LL in the preferred case. However, as with the upper horizontal member 100, the present invention is not intended to be limited to this preferred embodiment. Therefore, the dimensions and shape of the right side male engager 106L and female engaging surface 108L may differ from those of the left side male engager 106L and female engaging surface 108L. What is required in all embodiments is that the male engager 106L comprises a head 110 with a maximum width that is wider than the minimum width of the neck 112 and that the female engaging surface 108L comprises a head section 114L with a maximum width that is wider than the minimum width of the neck section 116L.

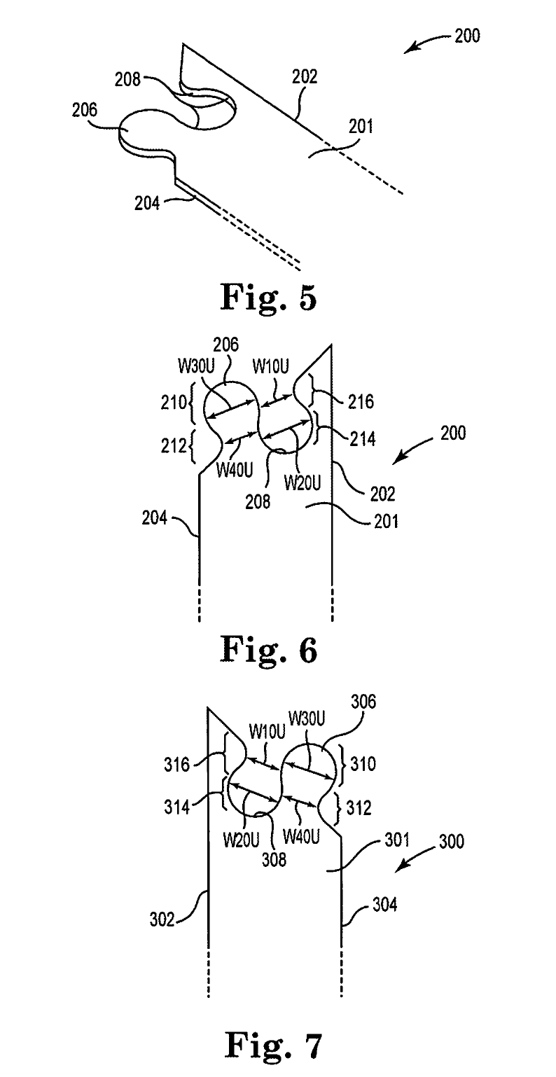

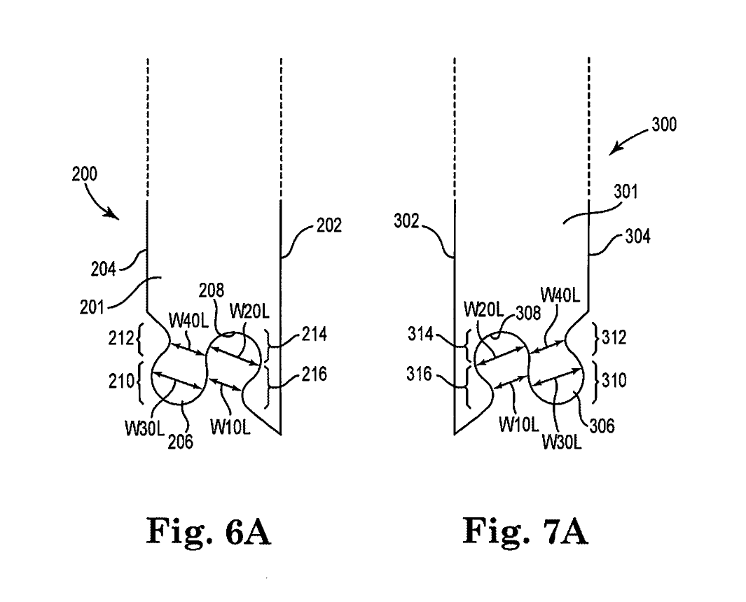

Turning now to FIGS. 5 and 6, one embodiment of the upper portion of the right vertical member 200 is illustrated. The right vertical member 100 comprises a body 201 and an elongated vertical surface 202 and a shortened vertical surface 204 on opposing sides of the body 201. The member 200 further comprises a male engager 206 and a female engaging surface 208 defined on the upper end of the body 201.

The male engager 206 comprises a head 210 and a neck 212, each comprising a width, wherein the head 210 maximum width W30U is wider than the neck 212 minimum width W40U.

Similarly, the female engaging surface 208 comprises a head section 214 and a neck section 216, each comprising a width, wherein the head section 214 maximum width W20U is wider than the minimum width W10U of neck 216.

FIG. 6A illustrates one embodiment of the lower right vertical member 200, which is needed in the case of a window casing since a lower horizontal member will be required as illustrated in FIG. 4 to complete the four-sided casing. As illustrated, the geometry and size of the male engager 206 and the female engaging surface 208 are mirror images of the upper portion of the right vertical member 200 illustrated in FIGS. 5 and 6.

Thus, the lower right vertical member 200 as illustrated comprises a male engager 206 and a female engaging surface 208 defined on the upper end of the body 201.

The male engager 206 comprises a head 210 and a neck 212, each comprising a width, wherein the head 210 maximum width W30L is wider than the neck 212 minimum width W40L.

Similarly, the female engaging surface 208 comprises a head section 214 and a neck section 216, each comprising a width, wherein the head section 214 maximum width W20L is wider than the minimum width W10L of neck 216.

FIG. 7 illustrates one embodiment of the upper portion of the left vertical member 300. The left vertical member 300 comprises a body 301 and an elongated vertical surface 302 and a shortened vertical surface 304 on opposing sides of the body 301. The member 300 further comprises a male engager 306 and a female engaging surface 308 defined on the upper end of the body 301.

The male engager 306 comprises a head 310 and a neck 312, each comprising a width, wherein the head 310 maximum width W30U is wider than the neck 312 minimum width W40U.

Similarly, the female engaging surface 308 comprises a head section 314 and a neck section 316, each comprising a width, wherein the head section 314 maximum width W20U is wider than the neck section 316 minimum width W10U.

Turning now to FIG. 7A, one embodiment of the lower left vertical member 300, needed in the case of a four-sided casing, is provided. As illustrated, the geometry and size of the male engager 306 and the female engaging surface 308 are mirror images of the upper portion of the left vertical member 300 illustrated in FIG. 7.

Thus, the lower left vertical member 300 as illustrated comprises a male engager 306 and a female engaging surface 308 defined on the upper end of the body 301.

The male engager 306 comprises a head 310 and a neck 312, each comprising a width, wherein the head 310 maximum width W30L is wider than the neck 312 minimum width W40L.

Similarly, the female engaging surface 308 comprises a head section 314 and a neck section 316, each comprising a width, wherein the head section 314 maximum width W20L is wider than the minimum width W10L of neck 316.

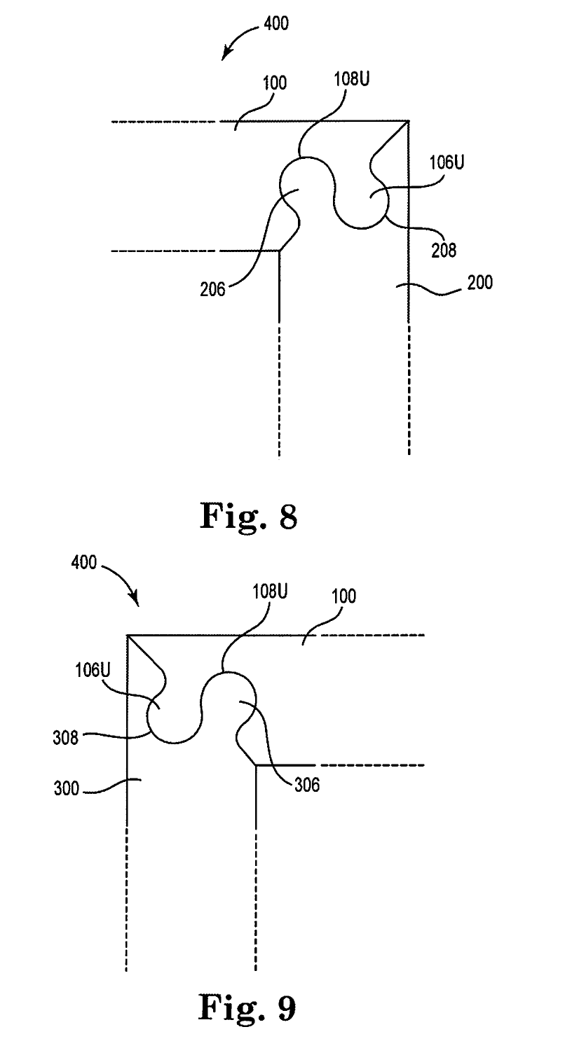

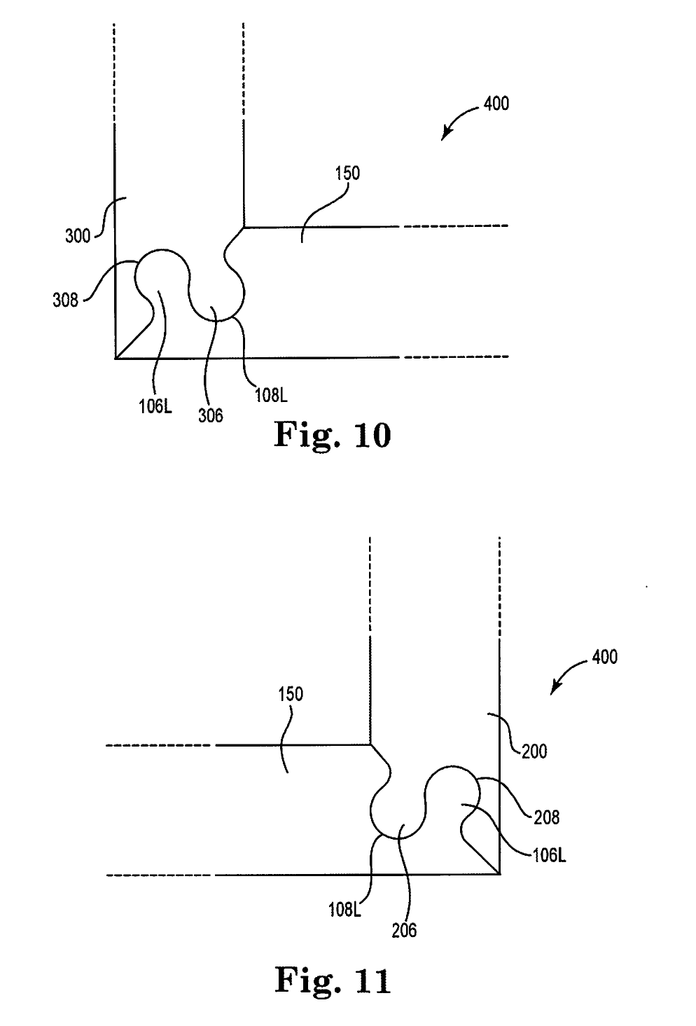

The individual members having been described in detail, the assembly of the casing 400 will now be discussed. FIGS. 8-11 show various embodiments of the lock joint of the present invention. FIGS. 8 and 9 illustrate the upper right and upper left corners of the assembled casing, respectively. FIGS. 10 and 11 illustrate the lower left and lower right corners of the assembled casing, respectively.

Thus, FIG. 8 illustrates upper horizontal member 100 in locked engagement with right vertical member 200. Specifically male engager 106U of upper horizontal member 100 fits within the female engaging surface 208 of vertical member 200 and male engager 206 of right vertical member 200 fits within the female engaging surface 108U of upper horizontal member 100.

This locked engagement is created by sizing the respective engagement elements so that there is a complementary and tight fit. Accordingly, male engager 106U's dimensions are complementary with those of the female engaging surface 208, within which male engager 106U is engaged. Similarly, male engager 206's dimensions are complementary with those of the female engaging surface 108U, within which male engager 206 is engaged. Because the male engager 106U's maximum head 110 width W2R is larger than its minimum neck 112 width W1R, and because male engager 206's maximum head 210 width W30U is larger than its minimum neck 212 width W40U, and because the respective female engaging surfaces 208 and 108U are complementary with, respectively, the male engagers' 106 and 206 when in locked engagement therewith as illustrated, any movement along the plane on which the casing 400 lies is severely limited.

FIG. 9 provides a similar locked engagement between upper horizontal member 100 and left vertical member 300. Specifically, male engager 106U of upper horizontal 100 fits within the female engaging surface 308 of vertical member 300 and male engager 306 fits within the female engaging surface 108U of upper horizontal member 100

Again, the locked engagement is created by sizing the respective engagement elements so that there is a complementary and tight fit. Accordingly, male engager 106U's dimensions are complementary with those of the female engaging surface 308, within which male engager 106U is engaged. Similarly, male engager 306's dimensions are complementary with those of the female engaging surface 108U, within which male engager 306 is engaged. Because the male engager 106U's maximum head 110 width W2L is larger than its minimum neck 112 width W1L, and because male engager 306's maximum head 310 width W30U is larger than its minimum neck 312 width W40U, and because the respective female engaging surfaces 308 and 108U are complementary with, respectively, the male engagers' 106 and 306 when in locked engagement therewith as illustrated, any movement along the plane on which the casing 400 lies is severely limited.

In the case of a door casing, the embodiment provided by the combination of FIGS. 8 and 9 provides the required three-sided casing 400.

FIG. 10 provides a similar locked engagement between lower horizontal member 150 and left vertical member 300. Specifically, male engager 106L of lower horizontal member 150 fits within the female engaging surface 308 of vertical member 300 and male engager 306 fits within the female engaging surface 108L of lower horizontal member 150.

Again, the locked engagement is created by sizing the respective engagement elements so that there is a complementary and tight fit. Accordingly, male engager 106L's dimensions are complementary with those of the female engaging surface 308, within which male engager 106L is engaged. Similarly, male engager 306's dimensions are complementary with those of the female engaging surface 108L, within which male engager 306 is engaged. Because the male engager 106L's maximum head 110L width W2LL is larger than its minimum neck 112L width W1LL, and because male engager 306's maximum head 310 width W30L is larger than its minimum neck 312 width W40L, and because the respective female engaging surfaces 308 and 108L are complementary with, respectively, the male engagers' 106L and 306 when in locked engagement therewith as indicated in the Figure, any movement along the plane on which the casing 400 lies is severely limited.

Finally, to complete a four-sided casing 400, FIG. 11 provides a locked engagement between lower horizontal member and right vertical member 200. Specifically male engager 106L of lower horizontal member 150 fits within the female engaging surface 208 of vertical member 200 and male engager 206 of right vertical member 200 fits within the female engaging surface 108L of upper horizontal member 100.

This locked engagement is created by sizing the respective engagement elements so that there is a complementary and tight fit. Accordingly, male engager 106L's dimensions are complementary with those of the female engaging surface 208, within which male engager 106L is engaged. Similarly, male engager 206's dimensions are complementary with those of the female engaging surface 108L, within which male engager 206 is engaged. Because the male engager 106L's maximum head 110L width W2RL is larger than its minimum neck 112L width W1RL, and because male engager 206's maximum head 210 width W30L is larger than its minimum neck 212 width W40L, and because the respective female engaging surfaces 208 and 108L are complementary, respectively, to the male engagers' 106L and 206, when in locked engagement therewith, any movement along the plane on which the casing 400 lies is severely limited.

The embodiments illustrated comprise members having a single male engager and a single female engaging surface, each being complementary in geometry, i.e, shape and size, with a single female engaging surface and a single male engager, respectively, on an adjacent member. This is a preferred embodiment, though the skilled artisan will readily recognize that the present invention is not limited to just one male engager and/or female engaging surface. The present invention may comprise more than one male engager and/or more than one female engaging surface per member in the casing structure. For example, the horizontal member(s) may comprise two male engagers on both the right and left side in addition to one female engaging surface. In this embodiment, both the right and left vertical members will require two complementary female engaging surfaces at both the upper and lower portions of each member to lockingly engage the two male engagers, as well as one male engager to engage the female engaging surface of the horizontal members. What is required is that each member of the casing structure comprise at least one male engager and at least one female engager, with complementary geometry on the adjacent member(s). Many alternative embodiments present themselves, each of which are well within the scope of the present invention.

The members of the present invention may be constructed using a jig which is shaped to provide the necessary complementary geometry, i.e., the at least one male engager and the at least one female engager for each member and each adjacent member pair. As is well understood, the jig is fashioned to provide essentially a negative image of the desired member shaping. Each member of the casing structure will require its own jig. The jig may be formed of any material which will hold its shape, i.e., wood, metal, plastic and the like. Once formed, the jig may be placed over the wood to be used for a member, the outline of the at least one male engager and at least one female engager traced or otherwise marked. The jig may be removed, or may be left in place, and the tracings or markings are then used to cut the at least one male engager and at least one female engager shapes.

Further, each member of the casing structure discussed herein may be formed, as will be recognized by the skilled artisan, by machining the geometry and structures discussed.

The present invention should not be considered limited to the particular examples described above, but rather should be understood to cover all aspects of the invention. Various modifications, equivalent processes, as well as numerous structures to which the present invention may be applicable will be readily apparent to those of skill in the art to which the present invention is directed upon review of the present specification.

What is claimed is:

1. A casing structure, the structure comprising:
a upper horizontal member comprising a right side and a left side, the right side comprising at least one male engager having a geometry and at least one female engaging surface having a geometry, the left side comprising at least one male engager having a geometry and at least one female engager having a geometry;
a right vertical member comprising an upper section and a lower section and at least one male engager and at least one female engager on at least the upper section, the at least one male engager having a geometry that is complementary with the geometry of the right side female engaging surface of the upper horizontal member, the at least one female engaging surface having a geometry that is complementary with the geometry of the right side male engager of the upper horizontal member; and
a left vertical member comprising an upper section and a lower section and at least one male engager and at least one female engager on at least the upper section at least one male engager and at least one female engager, the at least one male engager having a geometry that is complementary with the geometry of the left side female engaging surface of the upper horizontal member, the at least one female engaging surface having a geometry that is complementary with the geometry of the left side male engager of the upper horizontal member.

2. The casing structure of claim 1, further comprising the right vertical member in locked engagement with the right side of the upper horizontal member.

3. The casing structure of claim 2, further comprising the left vertical member in locked engagement with the right side of the upper horizontal member.

4. The casing structure of claim 3, wherein the at least one male engager of the right vertical member is in locked engagement with the at least one female engaging surface of the right side of the upper horizontal member, and wherein the at least one female engaging surface is in locked engagement with the at least one male engager of the right side of the upper horizontal member.

5. The casing structure of claim 4, wherein the at least one male engager of the right vertical member is in locked engagement with the at least one female engaging surface of the left side of the upper horizontal member, and wherein the at least one female engaging surface is in locked engagement with the at least one male engager of the left side of the upper horizontal member.

6. The casing structure of claim 1, further comprising a lower horizontal member comprising a right side and a left side, the right side comprising at least one male engager having a geometry and at least one female engaging surface having a geometry, the left side comprising at least one male engager having a geometry and at least one female engager having a geometry.

7. The casing structure of claim 6, wherein the right and left vertical members each comprise lower portions, the right vertical member comprising at least one male engager and at least one female engager on at least the lower section, the at least one male engager having a geometry that is complementary with the geometry of the right side female engaging surface of the lower horizontal member, the at least one female engaging surface having a geometry that is complementary with the geometry of the right side male engager of the lower horizontal member, the left vertical member comprising at least one male engager and at least one female engager on at least the lower section, the at least one male engager having a geometry that is complementary with the geometry of the left side female engaging surface of the lower horizontal member, the at least one female engaging surface having a geometry that is complementary with the geometry of the left side male engager of the lower horizontal member.

8. The casing structure of claim 7, further comprising the right vertical member in locked engagement with the right side of the lower horizontal member.

9. The casing structure of claim 8, further comprising the left vertical member in locked engagement with the left side of the lower horizontal member.

10. The casing structure of claim 8, wherein the at least one male engager of the lower portion of the right vertical member is in locked engagement with the at least one female engaging surface of the left side of the lower horizontal member, and wherein the at least one female engaging surface of the lower portion of the right vertical member is in locked engagement with the at least one male engager of the right side of the lower horizontal member.

11. The casing structure of claim 9, wherein the at least one male engager of the lower portion of the left vertical member is in locked engagement with the at least one female engaging surface of the left side of the lower horizontal member, and wherein the at least one female engaging surface of the lower portion of the left vertical member is in locked engagement with the at least one male engager of the left side of the lower horizontal member.

12. The casing structure of claim 7, further comprising:
the at least one male engager of the right and left sides of the upper horizontal member having a maximum width and a minimum width, wherein the maximum width is wider than the minimum width;
the at least one female engaging surface of the right and left sides of the upper horizontal member having a maximum width and a minimum width, wherein the maximum width is wider than the minimum width;
the at least one male engager of the upper portion of the right and left vertical members having a maximum width and a minimum width, wherein the maximum width is wider than the minimum width;
the at least one female engaging surface of the upper portion of the right and left vertical members having a maximum width and a minimum width, wherein the maximum width is wider than the minimum width;
the at least one male engager of the right and left sides of the lower horizontal member having a maximum width and a minimum width, wherein the maximum width is wider than the minimum width; and
the at least one female engaging surface of the right and left sides of the lower horizontal member having a maximum width and a minimum width, wherein the maximum width is wider than the minimum width.

13. A method for providing locking joints in a casing structure, comprising:
providing a upper horizontal member comprising a right side and a left side, the right side comprising at least one male engager having a geometry and at least one female engaging surface having a geometry, the left side comprising at least one male engager having a geometry and at least one female engager having a geometry;
providing a right vertical member comprising an upper section and a lower section and at least one male engager and at least one female engager on at least the upper section, the at least one male engager having a geometry that is complementary with the geometry of the right side female engaging surface of the upper horizontal member, the at least one female engaging surface having a geometry that is complementary with the geometry of the right side male engager of the upper horizontal member;
providing a left vertical member comprising an upper section and a lower section and at least one male engager and at least one female engager on at least the upper section at least one male engager and at least one female engager, the at least one male engager having a geometry that is complementary with the geometry of the left side female engaging surface of the upper horizontal member, the at least one female engaging surface having a geometry that is complementary with the geometry of the left side male engager of the upper horizontal member;
lockingly engaging the at the at least one male engager of the lower portion of the right vertical member with the at least one female engaging surface of the left side of the lower horizontal member;
lockingly engaging the at least one female engaging surface of the lower portion of the right vertical member with the at least one male engager of the right side of the lower horizontal member;
lockingly engaging the at least one male engager of the lower portion of the left vertical member with the at least one female engaging surface of the left side of the lower horizontal member; and
lockingly engaging the at least one female engaging surface of the lower portion of the left vertical member with the at least one male engager of the left side of the lower horizontal member.

14. The method of claim 13, further comprising:
providing a lower horizontal member comprising a right side and a left side, the right side comprising at least one male engager having a geometry and at least one female engaging surface having a geometry, the left side comprising at least one male engager having a geometry and at least one female engager having a geometry, and wherein the right and left vertical members each comprise lower portions, the right vertical member comprising at least one male engager and at least one female engager on at least the lower section, the at least one male engager having a geometry that is complementary with the geometry of the right side female engaging surface of the lower horizontal member, the at least one female engaging surface having a geometry that is complementary with the geometry of the right side male engager of the lower horizontal member, the left vertical member comprising at least one male engager and at least one female engager on at least the lower section, the at least one male engager having a geometry that is complementary with the geometry of the left side female engaging surface of the lower horizontal member, the at least one female engaging surface having a geometry that is complementary with the geometry of the left side male engager of the lower horizontal member.

15. The method of claim 14, further comprising:
lockingly engaging the at least one male engager of the lower portion of the right vertical member with the at least one female engaging surface of the left side of the lower horizontal member;
lockingly engaging the at least one female engaging surface of the lower portion of the right vertical member with the at least one male engager of the right side of the lower horizontal member;
lockingly engaging the at least one male engager of the lower portion of the left vertical member with the at least one female engaging surface of the left side of the lower horizontal member; and
lockingly engaging the at least one female engaging surface of the lower portion of the left vertical member with the at least one male engager of the left side of the lower horizontal member.

16. The method of claim 14, wherein the at least one male engager and at least one female engaging surface of the upper horizontal member, lower horizontal member, right vertical member and left vertical member is formed by use of a jig.

17. The method of claim 14, wherein the at least one male engager and at least one female engaging surface of the upper horizontal member, lower horizontal member, right vertical member and left vertical member is formed by machining.
